(19) United States
(12) Patent Application Publication
(10) Pub. No.: US 2022/0290723 A1
(43) Pub. Date: Sep. 15, 2022

(54) DRIVE SPLINES WITH FRICTION-REDUCING COATING

(71) Applicant: Textron Innovations Inc., Providence, RI (US)

(72) Inventors: Ron Woods, Weatherford, TX (US); Gary Dale Hall, Grand Prairie, TX (US); Scott David Poster, Arlington, TX (US); Lance William Weihmuller, Arlington, TX (US); Charles Hubert Speller, Flower Mound, TX (US)

(73) Assignee: Textron Innovations Inc., Providence, RI (US)

(21) Appl. No.: 17/694,234

(22) Filed: Mar. 14, 2022

Related U.S. Application Data
(60) Provisional application No. 63/160,925, filed on Mar. 14, 2021.

(51) Int. Cl. F16D 1/10

(52) U.S. Cl. CPC F16D 1/10; F16D 2001/103; F16D 2300/10

(57) ABSTRACT

A torque-transfer component has splines configured for engaging a corresponding feature of another component, at least a portion of each spline being hardened before a friction-reducing surface coating is applied to the splines. The splines are preferably hardened by nitriding, carburizing, induction hardening, or laser hardening, and the friction-reducing coating preferably comprises diamond-like carbon or tungsten carbide. The coating can be applied using, for example, physical vapor deposition, chemical vapor deposition, chemically assisted physical vapor deposition, autocatalytic electroless deposition, electroplating, or an oxygen fuel gun.

### CROSS-REFERENCE TO RELATED APPLICATIONS

This application claims priority to US 63/160,925, filed 14 Mar. 2021 by Ron Woods, et al., and titled “Drive Splines with Friction-Reducing Coating,” the disclosure of which is incorporated by reference in its entirety.

### STATEMENT REGARDING FEDERALLY SPONSORED RESEARCH OR DEVELOPMENT

Not applicable.

### BACKGROUND

Rotorcraft typically transfer power created by an engine (or other torque source) through a transmission to a mast for rotating blades to provide thrust for the aircraft. In some designs, the mast is coupled to the transmission by splines that mesh with splines of an output of the transmission. During operation, the mast may bend and cause axial motion between the engaged splines, which can damage splines due to friction.

### BRIEF DESCRIPTION OF THE DRAWINGS

FIG. 1 illustrates a side view of an aircraft according to an embodiment of this disclosure.

FIG. 2 illustrates a side section view of a transmission and mast assembly of the aircraft of FIG. 1.

FIG. 3 illustrates a flowchart of a method according to an embodiment of this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure provides a rotorcraft including a mast and an torque source with an associated transmission. Splines of the mast mesh with corresponding splines of an output of the transmission. The splines are coated with a hard coating to reduce friction between the splines for reducing wear to and damage of the splines during operation.

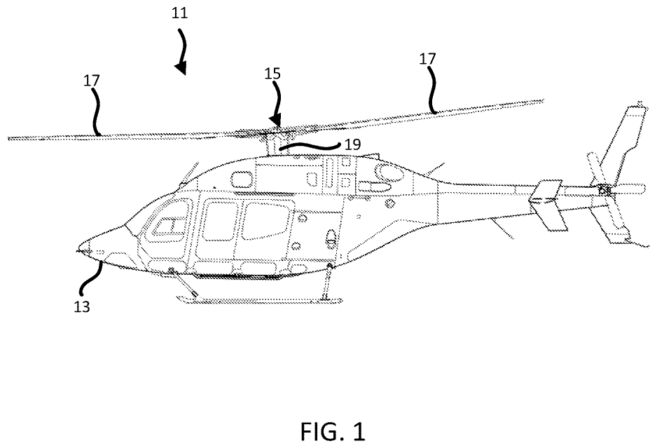

FIG. 1 illustrates a helicopter 11, which includes a fuselage 13 and a rotor assembly 15 having a plurality of blades 17 coupled to a mast 19. In operation, rotor assembly 15 is operated by a torque source, such as an engine or an electric motor, and associated transmission of helicopter 11 to provide thrust for helicopter 11.

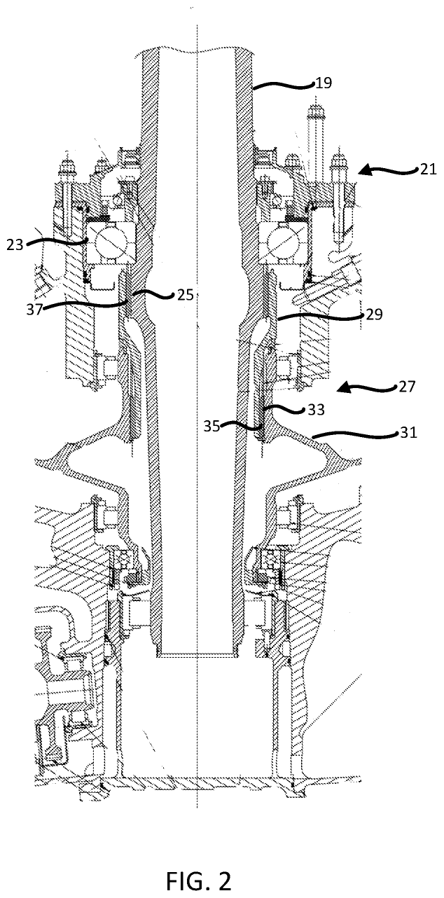

Referring to FIG. 2, mast 19 is rotatably supported in a mast housing 21 of fuselage 13 by a bearing assembly 23 and comprises a plurality of external splines 25 coupling mast 19 with an output 27 of the transmission of helicopter 11. Transmission output 27 includes a mast adapter 29 and a bevel gear 31 comprising a plurality of internal splines 33 and configured to be rotated by the transmission of helicopter 11. Mast adapter 29 is an elongated generally cylindrical structure comprising a plurality of external splines 35 on a first end of mast adapter 29 and a plurality of internal splines 37 on a second end of mast adapter 29. External splines 35 of mast adapter 29 mesh with internal splines 33 of gear 31 to couple mast adapter 29 to gear 31. External splines 25 of mast 19 mesh with internal splines 37 of mast adapter 29 to couple mast 19 to mast adapter 29 for transferring torque therebetween. Thus, transmission output 27 can rotate mast 19 based on splines 25 coupling mast 19 to mast adapter 29.

During operation, mast 19 can bend to accommodate the various thrust, torsion, and shear forces experienced by rotor assembly 15. The bending of mast 19 can cause axial motion, or sliding, between external splines 25 and corresponding internal splines 37. The axial motion and/or angular misalignment can cause damage, such as galling, pitting, and wear, to splines 25 and 37 due to the friction between splines 25 and 37. Thus, if the coefficient of friction between splines 25 and 37 can be reduced, damage to splines 25 and 37 can be reduced when bending of the shaft occurs.

To reduce the coefficient of friction between splines 25 and 37, a hard coating is applied to splines 25 or 37. The coating has a coefficient of friction lower than the coefficient of friction of the surfaces of splines 25 and 37. In some embodiments, the coating is applied to one of either external splines 25 or internal splines 37. For example, in preferred embodiments, the hard coating is applied to surfaces of external splines 25 that contact internal splines 37 and is not applied to internal splines 37. However, in some embodiments, the hard coating is applied to surfaces of internal splines 37 that contact external splines 25 and is not applied to external splines 25. Additionally, in some embodiments, the coating is applied to surfaces of both external splines 25 and internal splines 37. Although this disclosure commonly describes that the coating is applied to surfaces of external splines 25, one with skill in the art will recognize that the coating can be applied to surfaces of external splines 25 and/or internal splines 37.

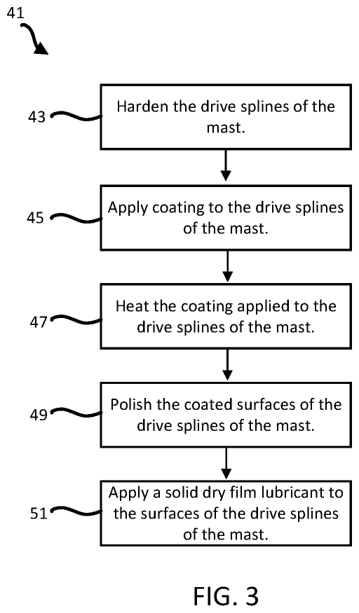

Referring to FIG. 3, a method 41 of applying the friction-reducing coating to surfaces of external splines 25 that contact internal splines 37 will be described. At block 43, method 41 can begin by hardening splines 25. Hardening of splines 25 can be performed using any of a number of different processes. In some embodiments, splines 25 are hardened by a laser-hardening or induction-hardening process. Laser hardening has an advantage of allowing for only one or more portions of a spline, such as, for example, a tooth surface, to be selectively hardened, thereby eliminating potential adverse stress effects in the root fillet area of the splines when hardening the entire spline. In some embodiments, splines 25 are hardened by Nitriding, in which nitrogen is diffused into the surface of splines 25 to harden the surfaces of splines 25. Carburization is another common form of hardening certain metals; however, in some embodiments, mast 19 and integrally formed splines 25 are made of a metal that cannot be carburized. For example, in some embodiments, mast 19 and integrally formed splines 25 are made from 4340 steel, which has material properties, such as hardness, that can degrade when the steel is subjected to the high temperatures at which carburization takes place. Accordingly, splines 25 can be hardened by laser-hardening or Nitriding when splines 25 are made of a material that cannot be hardened by carburization. In addition, a stainless steel may be used that has been heat treated to achieve the material characteristics required for the specific application.

At block 45, method 41 can continue by applying a coating to the surfaces of external splines 25 that contact internal splines 37. The coating has a coefficient of friction that is less than the coefficient of friction of the surfaces of splines 25. Thus, the coating is configured to lower the amount of friction between external splines 25 and internal splines 37. In preferred embodiments, the coating is a hard coating, as opposed to a soft coating. Soft coatings, such as oils, are not suitable for reducing friction between splines 25 and 37 because, during operation, soft coatings are often pushed away from where splines 25 and 37 come into contact. Accordingly, in preferred embodiments, a hard coating is applied to splines 25. The hard coating can be, for example: a diamond-like coating, such as, for example, SPEC-P51+™ by United Protective Technologies; a Tungsten Carbide/Carbon (“WC/C”) based coating, such as, for example, Balinit® C by Oerlikon Balzers; a Nano Tungsten Carbide coating, such as, for example, the Curtiss-Wright High Velocity Oxy-Fuel applied Nano Tungsten Carbide; or an Electroless Nickel coating, such as, for example, Niklad™ ELV 824. Although specific hard coatings have been described, one with skill in the art will understand that other hard coatings with low coefficients of friction can be applied to splines 25 without departing from the scope of this disclosure. The hard coating can be applied to splines 25 using any of a number of coating application processes. For example, the hard coating can be applied to splines 25 by physical vapor deposition, chemical vapor deposition, chemically assisted physical vapor deposition, a high velocity oxygen fuel gun, autocatalytic electroless deposition, or electroplating, depending on the hard coating applied to splines 25.

Some hard coatings can be applied to splines 25 at an application temperature less than or equal to 300 degrees Fahrenheit, which is less than temperatures at which hard coatings are typically applied. In some embodiments, mast 19 and integrally formed splines 25 are made of a metal that can lose desirable hardness characteristics if the coating application is performed at typical application temperatures for hard coatings. For example, in some embodiments, mast 19 and splines 25 are made from 4340 steel, which has material properties, such as hardness, that can degrade when the steel is subjected to the high temperatures at which coating application typically takes place. Degradation to the hardness of the steel can lead to increased wear of splines 25. Accordingly, in embodiments where mast 19 is made of a material that could degrade when exposed to typical coating application temperatures, such as 4340 steel, the coating application temperature is preferably set to be less than or equal to 300 degrees Fahrenheit.

At block 47, method 41 can optionally continue by heating the coating applied to the surfaces of splines 25. In some embodiments, the coating application process can further use a low temperature baking operation to harden the coating applied to splines 25. For example, in some embodiments where the coating is applied to splines 25 by autocatalytic electroless deposition, the application process can further use a low temperature baking operation to harden the coating.

At block 49, method 41 can optionally continue by polishing or grinding the coated surfaces of splines 25 to further lower the coefficient of friction of the coated surfaces of splines 25.

At block 51, method 41 can optionally continue by applying a solid dry film lubricant to the surfaces of splines 25 to further lower the coefficient of friction of the surfaces of the splines 25.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A torque-transfer component, comprising:
splines configured for engaging a corresponding feature of another component;
wherein at least a portion each spline has been hardened; and
wherein a friction-reducing surface coating has been applied to the splines.

2. The component of claim 1, wherein the splines are hardened by nitriding and the friction-reducing coating comprises diamond-like carbon.

3. The component of claim 1, wherein the splines are hardened by nitriding and the friction-reducing coating comprises tungsten carbide.

4. The component of claim 1, wherein the splines are hardened by carburizing and the friction-reducing coating comprises diamond-like carbon.

5. The component of claim 1, wherein the splines are hardened by carburizing and the friction-reducing coating comprises tungsten carbide.

6. The component of claim 1, wherein the splines are induction hardened and the friction-reducing coating comprises diamond-like carbon.

7. The component of claim 1, wherein the splines are induction hardened and the friction-reducing coating comprises tungsten carbide.

8. The component of claim 1, wherein the splines are laser hardened and the friction-reducing coating comprises diamond-like carbon.

9. The component of claim 8, wherein only a spline tooth surface profile is hardened.

10. The component of claim 1, wherein the splines are laser hardened and the friction-reducing coating comprises tungsten carbide.

11. The component of claim 10, wherein only a spline tooth surface is hardened.

12. The component of claim 1, wherein the friction-reducing coating is applied using physical vapor deposition, chemical vapor deposition, chemically assisted physical vapor deposition, autocatalytic electroless deposition, electroplating, or an oxygen fuel gun.

13. A method of reducing wear on splines of a torque-transfer component, the method comprising:
(a) hardening at least a portion each spline; and then
(b) applying a friction-reducing surface coating to the splines.

14. The method of claim 13, wherein step (a) comprises nitriding, carburizing, induction hardening, or laser hardening.

15. The method of claim 13, wherein step (a) comprises laser hardening only a spline tooth surface of each spline.

16. The method of claim 13, wherein the friction-reducing coating comprises diamond-like carbon or tungsten carbide.

17. The method of claim 13, wherein step (b) comprises using physical vapor deposition, chemical vapor deposition, chemically assisted physical vapor deposition, autocatalytic electroless deposition, electroplating, or an oxygen fuel gun.

18. A rotorcraft, comprising:
a torque source;
a rotor mast having splines; and
a transmission configured for transferring torque from the torque source to the mast, a transmission output having splines that engage the splines of the mast;
wherein at least a portion of each spline of the mast or of the output has been hardened; and
wherein a friction-reducing surface coating has been applied to the hardened splines.

19. The rotorcraft of claim 18, wherein the splines are hardened by nitriding, carburizing, induction hardening, or laser hardening.

20. The rotorcraft of claim 18, wherein the friction-reducing coating comprises diamond-like carbon or tungsten carbide.
